(19) United States
(12) Patent Application Publication
(10) Pub. No.: US 2016/0049980 A1
(43) Pub. Date: Feb. 18, 2016

(54) Phone Case

(71) Applicant: Chul Joo KIM, Cypress, CA (US)

(72) Inventor: Chul Joo KIM, Cypress, CA (US)

(21) Appl. No.: 14/462,410

(22) Filed: Aug. 18, 2014

(51) Int. Cl. H04B 1/3888; A45C 11/00

(52) U.S. Cl. CPC H04B 1/3888; A45C 11/00; A45C 2011/002

(57) ABSTRACT

A protecting case is provided for a mobile electronic device, including a front edge frame, a rear edge frame, and a front cover. The front edge frame comprises an inner groove portion, an outer protrusion portion, and a front opening provided therethrough, and encloses and protects a front edge portion of the mobile electronic device. The rear edge frame comprises an inner groove portion, an outer protrusion portion, and a rear opening, and encloses and protects a rear edge portion of the mobile electronic device. The rear edge frame further comprises a side protecting portion and corner protecting portions extending toward the front edge frame so as to engage detachably to the front edge frame. The front cover is installed in the front opening so as to block a front surface of the mobile electronic device for protection.

### BACKGROUND OF THE INVENTION

The present invention relates to a protecting case. More particularly, this invention relates to a protecting case, which protects mobile electronic devices including smart phones.

These days, personal mobile devices are everywhere. Considering the popularity and usages, it is almost impossible to imagine a society or an individual without them. In other words, modern men or societies cannot stand for themselves alone.

One of the problems in such situations is that the mobile electronic devices are delicate machines and that they are prone to be slipped off the hands and broken so easily. The exposed screen and the edges are really vulnerable to dropping or colliding against edges or sharp points.

Accordingly, a need for a phone-protecting case has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a protecting case.

Another object of the invention is to provide a protecting case, which protects a mobile electronic device in several aspects.

An aspect of the invention provides a protecting case for a mobile electronic device comprising a front edge frame, a rear edge frame, and a front cover.

The front edge frame comprises an inner groove portion, an outer protrusion portion, and a front opening provided therethrough, and is configured to enclose and protect a front edge portion of the mobile electronic device.

The rear edge frame comprises an inner groove portion, an outer protrusion portion, and a rear opening, and is configured to enclose and protect a rear edge portion of the mobile electronic device. The rear edge frame further comprises a side protecting portion and a plurality of corner protecting portions extending toward the front edge frame so as to engage detachably to the front edge frame.

The front cover is installed in the front opening so as to block a front surface of the mobile electronic device for protection.

The front cover may comprise a plurality of mesas provided on an inner surface thereof, so that the front cover is maintained to stay away from a touch screen of the mobile electronic device with a specific interval.

The specific interval may be adjusted to an optimal value so as to be sensitive to the operation of the touch screen.

The plurality of mesas may be disposed evenly across the inner surface of the front cover in a pattern.

The front cover may be made of a protective and touchable film. The front edge frame may be made of an opaque thermoplastic polyurethane (TPU), that is colored in a specific color.

The front cover may further comprise an electro-magnetic-wave-absorbing band disposed along the inner edge portion of the front cover.

The electro-magnetic-wave-absorbing band may have predetermined thickness and width adjusted to maximize the absorption of external electro-magnetic wave.

The rear edge frame may be translucent so at to show an original color of the the mobile electronic device therethrough.

The protecting case may further comprise a plurality of first air bubbles, each of which being defined by the inner groove portion of the front edge frame, the inner groove portion of the rear edge frame, and a corresponding corner protecting portion of the rear edge frame, and provided at a corner portion of the mobile electronic device.

Each of the plurality of first air bubbles may be configured to provide an empty gap between the protecting case and the mobile electronic device.

The protecting case may further comprise a plurality of second air bubbles, each of which being provided at as inner surface of the side protecting portion of the rear edge frame.

One or two of the plurality of second air bubbles may be disposed adjacently to the corresponding first air bubble.

The second air bubble may be smaller and shallower than the first air bubble.

The rear opening may be configured to maximize thermal radiation therethrough.

The front edge frame and the front cover may be slightly curved out as going from the center to the edge.

The advantages of the present invention are: (1) the protecting case can protect the mobile electronic device; and (2) the protecting case provides double or triple protection to the mobile electronic device.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective front view showing a protecting case according to an embodiment of the present invention;

FIG. 2 is another perspective rear view showing the protecting case FIG. 1;

FIG. 3 is a front view of the protecting case of FIG. 1;

FIG. 4 is a partial perspective rear view of the protecting case of FIG. 3;

FIG. 5 is a cross-sectional view of the protecting case along the line V-V in FIG. 3; and

FIG. 6 is another cross-sectional view of the protecting case according to another embodiment of the invention.

### DETAILED DESCRIPTION EMBODIMENTS OF THE INVENTION

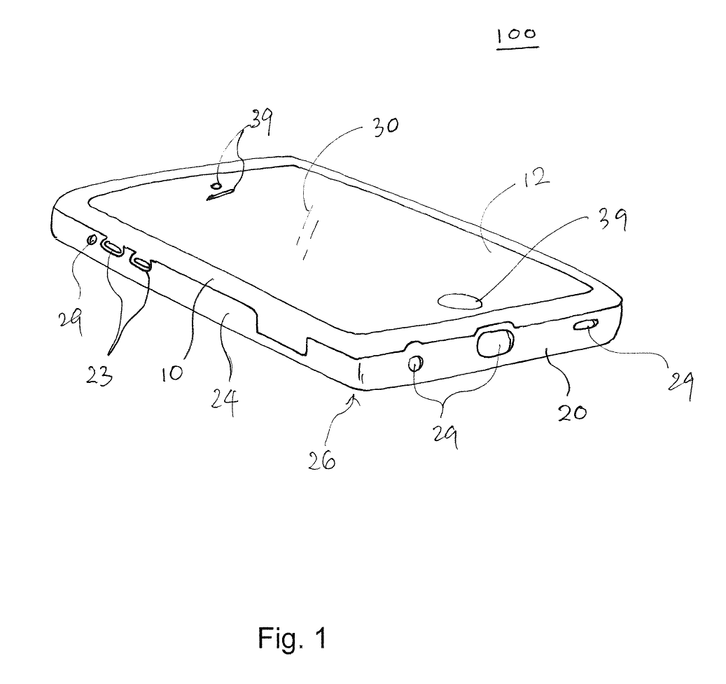

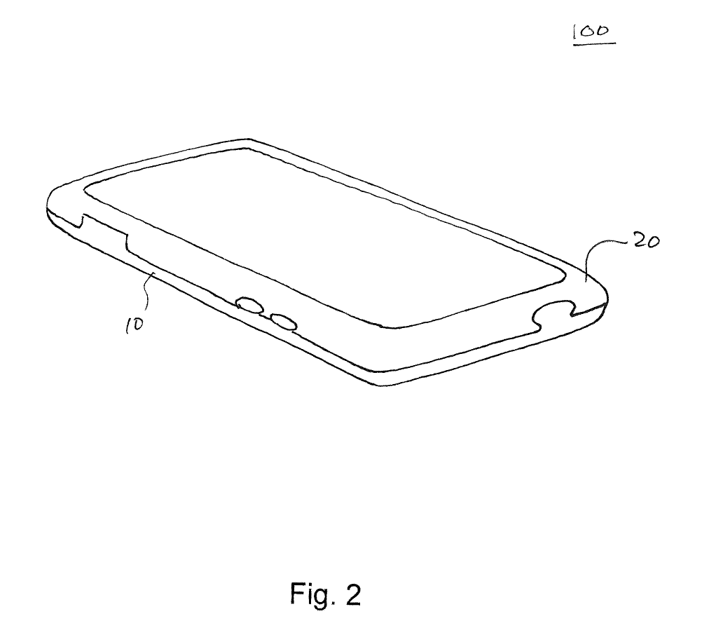

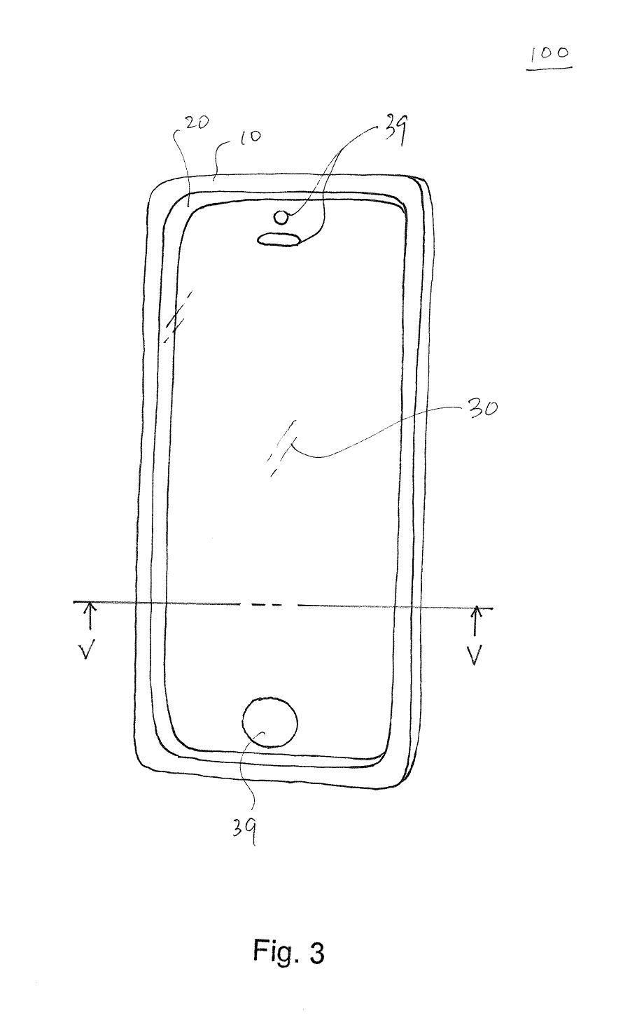

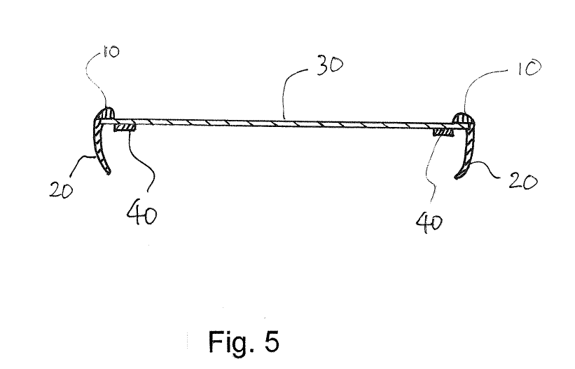

FIGS. 1-6 show protecting cases according to embodiments of the present invention.

An aspect of the invention provides a protecting case 100 for a mobile electronic device comprising a front edge frame 10, a rear edge frame 20, and a front cover 30 as shown in FIG. 1, where the mobile electronic device is enclosed by the protecting case 100 and not seen directly.

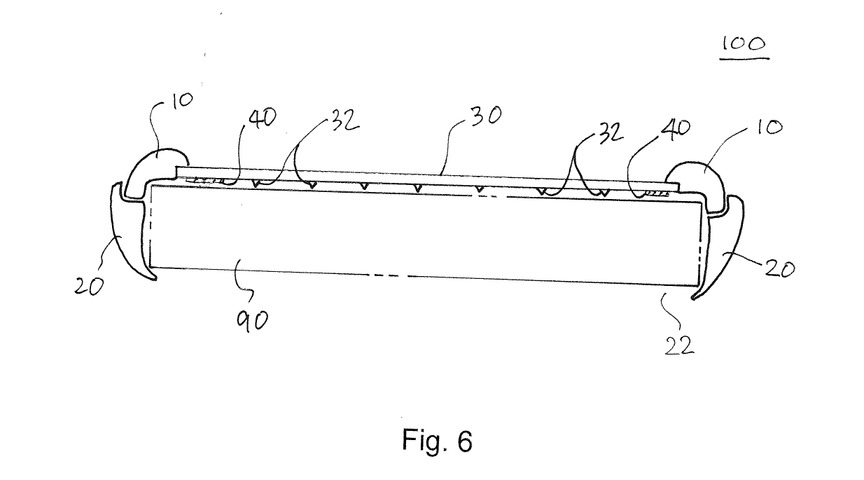

The front edge frame 10 comprises an inner groove portion, an outer protrusion portion, and a front opening 12 provided through the front edge frame 10, and is configured to enclose and protect a front edge portion of the mobile electronic device 90 as shown in FIG. 6. The front opening 12 is to be blocked by the front cover 30 as shown.

The rear edge frame 20 comprises an inner groove portion, an outer protrusion portion, and a rear opening 22, and is configured to enclose and protect a rear edge portion of the mobile electronic device 90. The rear edge frame 20 further comprises a side protecting portion 24 and a plurality of corner protecting portions 26 extending toward the front edge frame 10 so as to engage detachably to the front edge frame 10.

In certain embodiment, the front edge frame 10 may be attached to the rear edge frame 20 partially or entirely permanently using well-known conventional methods such as thermal welding or gluing.

The front cover 30 is installed in the front opening 12 so as to block a front surface of the mobile electronic device 90 for protection.

The front cover 30 may comprise a plurality of mesas 32 provided on an inner surface thereof, so that the front cover 30 is maintained to stay away from a touch screen of the mobile electronic device 90 with a specific interval.

The specific interval may be adjusted to an optimal value so as to be sensitive to the operation of the touch screen.

The plurality of mesas 32 may be disposed evenly across the inner surface of the front cover 30 in a pattern.

The front cover 30 may be made of a protective and touchable film. The front edge frame 10 may be made of an opaque TPU, that is colored in a specific color.

The front cover 30 may further comprise an electro-magnetic-wave-absorbing band 40 disposed along the inner edge portion of the front cover 30.

The electro-magnetic-wave-absorbing band 40 may have predetermined thickness and width adjusted to maximize the absorption of external electro-magnetic wave.

The rear edge frame 20 may be translucent so at to show an original color of the the mobile electronic device 90 therethrough.

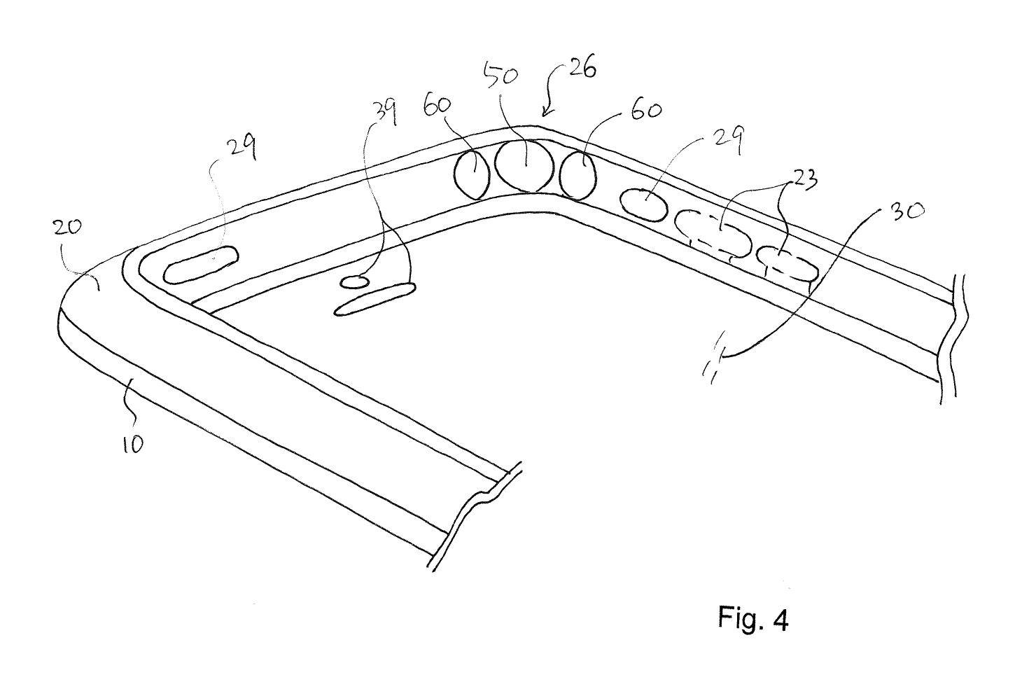

The protecting case 100 may further comprise a plurality of first air bubbles 50, each of which being defined by the inner groove portion of the front edge frame 10, the inner groove portion of the rear edge frame 20, and a corresponding corner protecting portion 26 of the rear edge frame 20, so as to cover or partially enclose a corner portion of the mobile electronic device 90 as shown in FIG. 4.

Each of the plurality of first air bubbles 50 may be configured to provide an empty gap between the protecting case 100 and the mobile electronic device 90 even when the protecting case 100 is pushed hard against the mobile electronic device 90. Of course, the exact position and dimension of the first air bubbles 50 may be adjusted with the variation of the local shape of bordering and bonding areas between the front edge frame 10 and the rear edge frame 20. The point is to provide extra shock-absorbing air bubbles or gaps around the corner of the mobile electronic device 90. Therefore, in certain embodiments, the air bubbles may be provided just on the side protecting portion 24 of the rear edge frame 20.

The protecting case 100 may further comprise a plurality of second air bubbles 60, each of which being provided at as inner surface of the side protecting portion 24 of the rear edge frame 20.

One or two of the plurality of second air bubbles 60 may be disposed adjacently to the corresponding first air bubble 50.

The second air bubble 60 may be smaller and shallower than the first air bubble 50.

The rear opening 22 may be configured to maximize thermal radiation therethrough.

The front edge frame 10 and the front cover 30 may be slightly curved out as going from the center to the edge in the direction of length or width or both.

Various shapes of holes 29 provided in the rear edge frame 20 are provided for accessing buttons or interfaces of the mobile electronic device 90.

Likewise, various shapes of holes 39 provided in the front cover 30 are provided also for accessing buttons or interfaces of the mobile electronic device 90.

In FIGS. 1 and 4, the front edge frame 10 and the rear edge frame 20 engage each other with a interlocking mechanism 23 using male/female protrusion-groove pair extending form the front edge frame 10 and the rear edge frame 20, respectively.

Usually, each of the first and second air bubbles 50, 60 has a gap of shapes of bubble, sphere, or oval, for such smoothly curved bubbles provide maximum shock-absorbing.

FIG. 6 shows the front edge frame 10 and the rear edge frame 20 are not connected to each other, which is just for describing the state before attaching them together in order to show them separately. They can be glued or welded thermally together using well-known conventional methods. Additionally, the illustrated shape or cross-section is also for an example, not limiting. In certain embodiments, the front edge frame 10 and the rear edge frame 20 may have a smooth outer profile, not rough.

Furthermore, the front edge frame 10 and the rear edge frame 20 are made of flexible material such as rubber or polymer material, so that the mobile electronic device 90 may be inserted through the rear opening 22 easily.

In certain embodiments of the invention, each of the front edge frame 10 and the rear edge frame 20 may be made of TPU. The front cover 30 may be made of Polymethyl methacrylate (PMMA) on the front surface thereof and polycarbonate (PC) on the rear surface that touches the screen of the mobile electronic device 90. That is, in an embodiment, the front cover 30 may be made of High Scratch Resistance Hard Coat on PC/PMMA 2 Layer Sheet, which is available in the market.

In certain embodiments of the invention, an UV embossing molding may be applied to the PMMA and PC portions, so as to have effects of easy wiping out of fingerprints and removing moire in the PC portion and the screen.

In certain embodiments of the invention, the electro-magnetic-wave-absorbing band 40 may be made of silver paste with Argentum powder 70% included.

Of course, these materials are not limiting. As far as providing the required properties, any material can be used for the respective parts.

The protecting case 100 according to embodiments of the invention provides:

protecting the mobile electronic device 90, for example, iPhone® from impact such as dropping on a hard surface;

protecting front screen of iPhone from hard/soft scratch;

heat emitting through opening in the rear side; and

reducing electromagnetic waves coming from iPhone.

In contrast, most phone cases include backside cover. So they cannot emit heat from the phone effectively. The accumulated heat may disturb sending/receiving signal and generate more electromagnetic waves.

The electro-magnetic-wave-absorbing band 40 can reduce the electromagnetic waves from inside and outside.

In this invention, the integrated air pockets or bubbles provided at all four corners protect the mobile electronic device 90 from damaging impact.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A protecting case for a mobile electronic device comprising:
a front edge frame comprising an inner groove portion, an outer protrusion portion, and a front opening provided therethrough and configured to enclose and protect a front edge portion of the mobile electronic device;
a rear edge frame comprising an inner groove portion, an outer protrusion portion, and a rear opening and configured to enclose and protect a rear edge portion of the mobile electronic device, wherein the rear edge frame further comprises a side protecting portion and a plurality of corner protecting portions extending toward the front edge frame so as to engage detachably to the front edge frame; and
a front cover installed in the front opening so as to block a front surface of the mobile electronic device for protection.

2. The protecting case of claim 1, wherein the front cover comprises a plurality of mesas provided on an inner surface thereof, so that the front cover is maintained to stay away from a touch screen of the mobile electronic device with a specific interval.

3. The protecting case of claim 2, wherein the specific interval is adjusted to an optimal value so as to be sensitive to the operation of the touch screen.

4. The protecting case of claim 2, wherein the plurality of mesas are disposed evenly across the inner surface of the front cover in a pattern.

5. The protecting case of claim 2, wherein the front cover is made of a protective and touchable film.

6. The protecting case of claim 5, wherein the front edge frame is made of an opaque thermoplastic polyurethane (TPU), that is colored in a specific color.

7. The protecting case of claim 1, wherein the front cover further comprises an electro-magnetic-wave-absorbing band disposed along the inner edge portion of the front cover.

8. The protecting case of claim 1, wherein the electro-magnetic-wave-absorbing band has predetermined thickness and width adjusted to maximize the absorption of external electro-magnetic wave.

9. The protecting case of claim 1, wherein the rear edge frame is translucent so at to show an original color of the the mobile electronic device therethrough.

10. The protecting case of claim 1, further comprising a plurality of first air bubbles, each of which being defined by the inner groove portion of the front edge frame, the inner groove portion of the rear edge frame, and a corresponding corner protecting portion of the rear edge frame, and provided at a corner portion of the mobile electronic device.

11. The protecting case of claim 10, wherein each of the plurality of first air bubbles is configured to provide an empty gap between the protecting case and the mobile electronic device.

12. The protecting case of claim 10, further comprising a plurality of second air bubbles, each of which being provided at as inner surface of the side protecting portion of the rear edge frame.

13. The protecting case of claim 12, wherein one or two of the plurality of second air bubbles are disposed adjacently to the corresponding first air bubble.

14. The protecting case of claim 13, wherein the second air bubble is smaller and shallower than the first air bubble.

15. The protecting case of claim 1, wherein the rear opening is configured to maximize thermal radiation therethrough.

16. The protecting case of claim 1, wherein the front edge frame and the front cover are slightly curved out as going from the center to the edge.
